(19) United States
(12) Patent Application Publication
(10) Pub. No.: US 2024/0081573 A1
(43) Pub. Date: Mar. 14, 2024

(54) ELECTRIC COOKING DEVICE, AND MIDDLE RING ASSEMBLY FOR AN ELECTRIC COOKING DEVICE

(71) Applicant: Instant Brands Holdings Inc., Downers Grove, IL (US)

(72) Inventors: Megan Donnelly, Darien, IL (US); Jason L. Lepinske, Schaumburng, IL (US)

(73) Assignee: Instant Brands Holdings Inc., Downers Grove, IL (US)

(21) Appl. No.: 18/455,018

(22) Filed: Aug. 24, 2023

Related U.S. Application Data
(60) Provisional application No. 63/405,948, filed on Sep. 13, 2022.

(51) Int. Cl. A47J 27/08; A47J 27/00; A47J 36/02

(52) U.S. Cl. CPC A47J 27/08; A47J 27/002; A47J 27/004; A47J 36/02

(57) ABSTRACT

An electric cooking device includes a removable lid and/or pot assembly, a lower housing surrounding a vessel configured to be heated, and a middle ring assembly positioned between the lower housing and the removable lid and/or pot assembly. The middle ring assembly comprises (i) an outer component seated with the lower housing that includes a decorative surface coating thereon, and (ii) an inner component having an outer portion seated with the outer component. An inner portion of the inner component is situated radially inward from and is unsupported by the outer component. The vessel engages the inner portion of the inner component and is thereby thermally decoupled from the outer component comprising the decorative surface coating.

### RELATED APPLICATION

This application claims the benefit of U.S. Provisional Patent Application No. 63/405,948, filed Sep. 13, 2022, the entirety of which is herein incorporated by reference.

### TECHNICAL FIELD

The present disclosure is related generally to kitchen appliances and more particularly to an electric cooking device.

### BACKGROUND

Electric cooking devices such as pressure cookers and dutch ovens may reach cooking temperatures in excess of 240° F. To ensure the safety of the user, heated metal components of such devices may be separated from the user by plastic or polymeric components, such as a lid and a housing, that may function in part as a thermal barrier between the user and the hot interior of the cooking device. For polymeric components that come into direct contact with the heated metal components, thermal stability (e.g., good creep resistance) may be an essential requirement. Polymeric components having exterior-facing surfaces may have additional aesthetic or functional requirements.

### BRIEF DESCRIPTION OF THE DRAWINGS

FIG. 1A shows a perspective view of an electric cooking device, in particular a pressure cooker, including a middle ring assembly positioned between a lid assembly and a lower housing that surrounds a heated vessel during operation of the device.

FIG. 1B shows the pressure cooker of FIG. 1A with the lid assembly removed.

FIG. 2A is a perspective view of the middle ring assembly.

FIG. 2B is an exploded view of the middle ring assembly.

FIG. 3 is a cross-sectional view showing the relationship between components of the middle ring assembly, the heated vessel, and the lower housing.

FIG. 4 is a perspective view of another electric cooking device, in particular a dutch oven, which may include the middle ring assembly.

### DETAILED DESCRIPTION

Described in this disclosure is an electric cooking device having a middle ring assembly configured for both heat-resistance and application of a decorative surface coating.

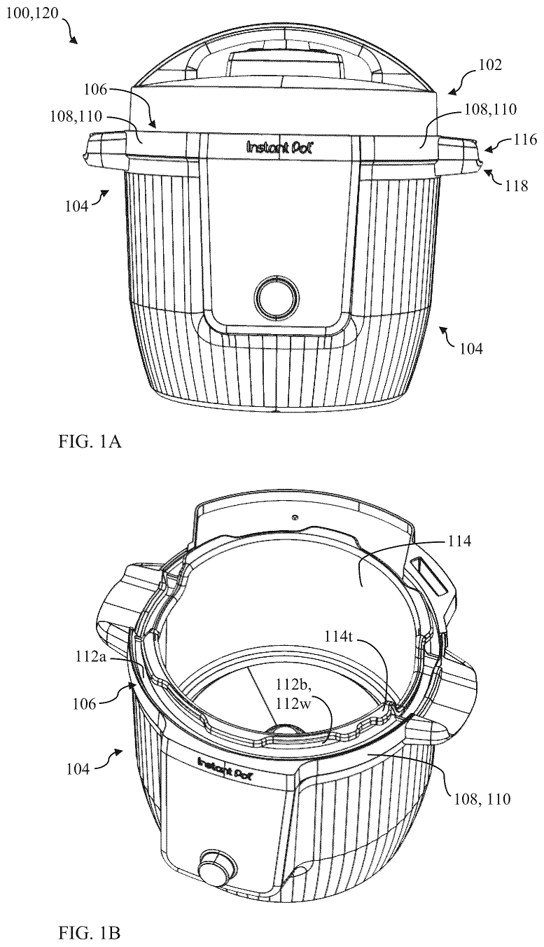

As shown in FIG. 1A, the electric cooking device 100 includes a removable lid assembly 102 and a lower housing 104 separated from the removable lid assembly 102 by a middle ring assembly 106. The lower housing 104 surrounds a vessel 114 (see FIG. 1B) which is configured to be heated and to contain a removable cooking pot. If the electric cooking device 100 is a pressure cooker 120, as illustrated in FIG. 1A, the vessel 114 may reach temperatures up to about 240° F. during operation. The lower housing 104 is spaced apart from the vessel 114; physical contact with the vessel 114 is made by the middle ring assembly 106, as explained below. Typically, the lower housing 104 comprises a polymer and is formed by injection molding, while the vessel 114 comprises a metal or alloy, such as stainless steel. The removable lid assembly 102 shown in FIG. 1A may include an upper lid portion and a lower lid portion, e.g., as described in U.S. Patent Application Publication 2022/0061576, which is hereby incorporated by reference.

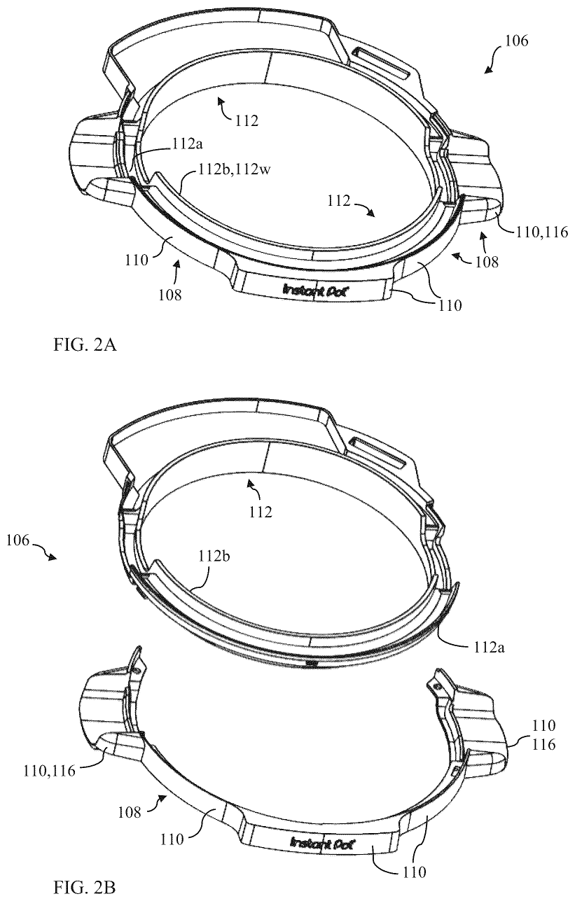

FIGS. 2A and 2B show a perspective view and an exploded view, respectively, of the middle ring assembly 106, which has a two-piece ring structure including an inner component 112 seated with an outer component 108. The inner component 112 comprises a heat-resistant polymer and the outer component 108, which includes exterior-facing surfaces, comprises a coating-adherent polymer with a decorative surface coating 110 thereon. Accordingly, the middle ring assembly 106 is configured for both heat resistance (inner component 112) and coating adhesion 110 (outer component 108). The middle ring assembly 106 may have a generally circular, elliptical, polygonal, curved polygonal, or other shape when viewed in cross-section. For example, as shown in FIG. 2A, an inner perimeter of the middle ring assembly 106 may have a generally circular shape.

When assembled as part of the electric cooking device 100, the inner component 112 of the middle ring assembly 106 engages the vessel 114 that undergoes heating, and the outer component 108, which includes the decorative surface coating 110, is seated with the lower housing 104. In example of FIGS. 1A and 1B, the electric cooking device 100 is a pressure cooker 120. In another example, the electric cooking device 100 may be a dutch oven 130, as shown in FIG. 4. In this alternative example, the removable lid assembly 102 discussed above may be better described as a removable pot assembly 132 including a removable lid and cooking pot.

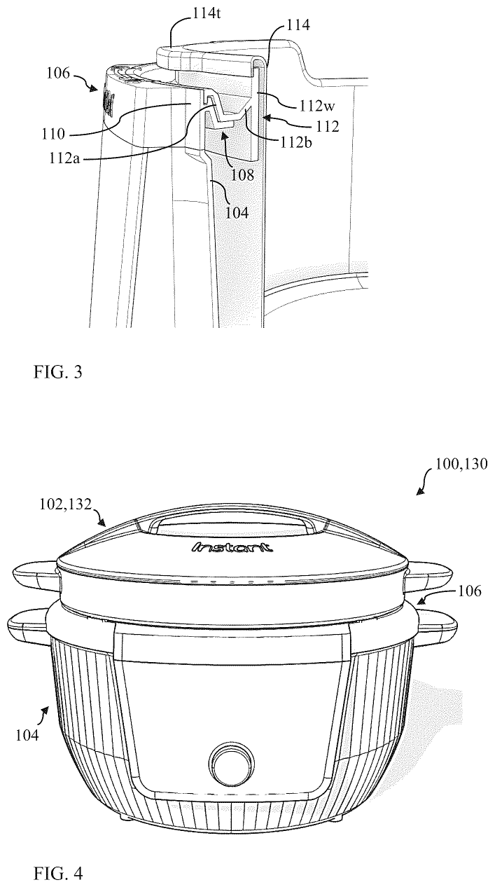

Referring now to FIGS. 2A and 2B, the inner component 112 has an outer portion 112a seated with the outer component 108 and an inner portion 112b situated radially inward from and unsupported by the outer component 108. It is noted that the term “radially inward” means toward a centerline of a device or component having a generally circular, elliptical, polygonal, curved polygonal, or other cross-sectional shape. Advantageously, (only) the inner portion 112b of the inner component 112 engages the vessel 114, as shown in FIG. 1B. More particularly, the inner portion 112b of the inner component 112 may include a vertically extending wall 112w from which radially extending tabs 114t on the (heated) vessel 114 may be suspended, where “radially extending” means extending in a direction away from a centerline of the vessel 114. Accordingly, the radially extending tabs 114t, the parts of the vessel 114 that extend radially closest to the outer component 108, may be vertically separated from the outer component 108 when the vessel 114 is engaged with the inner portion 112b. The engagement of the vessel 114 with the inner portion 112b of the inner component 112, the seating of the outer portion 112a of the inner component 112 with the outer component 108, and the seating of the outer component 108 with the lower housing 104 may be better understood by referring to the cross-sectional schematic of FIG. 3.

As a result of the configuration of the middle ring assembly 106, in use, the heated vessel 114 is thermally decoupled from the outer component 108 which includes the decorative surface coating 110. In other words, the outer component 108 of the middle ring assembly 106 is protected or isolated from the high temperatures reached by the vessel 114 during operation. This is important because polymers to which decorative coatings can adhere (and which may be employed for the outer component 108) may not have sufficient heat resistance to tolerate the elevated cooking temperatures to which the inner portion 112b of the inner component 112—which may be formed from a heat-resistant polymer—is exposed. In addition, the decorative surface coating 110 is applied at exterior-facing locations that may be touched by the user during operation of the electric cooking device 100, and it is desirable to avoid excessive heating of such touch locations. As indicated in FIG. 2A, one or more exterior-facing surfaces of the outer component 108 include the decorative surface coating 110. Accordingly, the decorative surface coating 110 is readily visible and accessible to the user of the electric cooking device 100. This approach of thermally decoupling a heated vessel or other heated component from another component that is accessible to a user and includes a decorative surface coating (e.g., by interposing a part or assembly configured to provide the thermal decoupling, such as the middle ring assembly described herein) may be applied to other electric appliances beyond the pressure cooker and dutch oven.

As indicated above, the outer component 108 further comprises a polymer underlying the decorative surface coating 110 that is selected for its ability to accept and bond to the surface coating 110. The polymer may thus be referred to as a coating-adherent polymer. The polymer may not have (and does not require) the thermal stability and/or low thermal conductivity of the heat-resistant polymer selected for the inner component 112. The coating-adherent polymer of the outer component 108 may comprise, for example, acrylonitrile butadiene styrene (ABS), perfluoroalkoxy alkane (PFA), polyamide-imide (PAI), polyether ether ketone (PEEK), polycarbonate (PC), polyethylene (PE), a polyamide (PA) such as nylon, polymethyl methacrylate (PMMA), polytetrafluoroethylene (PTFE), polystyrene (PS), polyimide (PI), polyurethane (PU), poly(3,4-ethylenedioxythiophene)-poly(styrenesulfonate) (PEDOT:PSS), styrene butadiene block copolymer (SBC), high-density polyethylene (HDPE), polyvinyl chloride (PVC), polylactic acide (PLA), polysulfone, polypyrrolle (PPy), and/or polyoxymethylene (polyacetal). Typically, the outer component 108 is formed by injection molding prior to applying the decorative surface coating 110. In some examples, the decorative surface coating 110 may be formed during the molding process.

The polymer employed for the inner component 112 may be thermally stable at the operating temperatures of the electric cooking device 100 and may further have a low thermal conductivity. Thus, the polymer may be referred to as a heat-resistant polymer. Suitable heat-resistant polymers may have a high heat distortion temperature (HDT), also known as deflection temperature under load (DTUL) or heat deflection temperature under load (HDTUL). Preferably, the HDT of the heat-resistant polymer exceeds the maximum operating temperature of the electric cooking device 100. The HDT may be determined according to the standard test method described in ASTM D648. In one example, the heat-resistant polymer used for the inner component 112 may have a HDT of at least 240° F. (116° C.) at 0.45 MPa, or at least 266° F. (130° C.) at 0.45 MPa. Also or alternatively, the heat-resistant polymer employed for the inner component 112 may have a low k-value, which is indicative of thermal conductivity (and, inversely, of the thermal insulation capability) of the polymer. More specifically, the heat-resistant polymer may have a k-value of about 0.4 W/m·K or less, and in some examples the heat-resistant polymer may have a k-value of about 0.3 W/m·K or less or about 0.2 W/m·K or less, and/or the k-value may be as low as about 0.1 W/m·K. The heat-resistant polymer employed for the inner component 112 may comprise a polyamide (PA), such as nylon, polypropylene (PP), polyethylene terephthalate (PET), or another polymer having a suitable HDT and/or k-value. The heat-resistant polymer may in some examples include reinforcement particles, such as glass beads or fibers, which may enhance the thermal stability (e.g., HDT or creep resistance) of the polymer, in addition to imparting higher strength and rigidity. For example, the heat-resistant polymer may be a glass-filled polyamide, such as glass-filled nylon, or glass-filled polypropylene. The heat-resistant polymer may include 20%-50% glass beads or fibers in a polyamide (e.g., nylon) or polypropylene matrix. As with the outer component 108, the inner component 112 may be formed by injection molding.

The decorative surface coating 110 may be applied to the outer component 108 by vacuum metallization, electroplating, powder coating, electrostatic painting, film insert molding, or co-molding, for example. In one example, the decorative surface coating 110 may be a metallic coating comprising one or more metals such as aluminum, chromium (“chrome”), copper, gold, nickel, silver, tin, titanium, and/or zinc. For example, after injection molding of a polymeric body shaped to become the outer component 108, the polymeric body may be positioned in a vacuum chamber for vacuum metallization or physical vapor deposition (PVD). In this process, a desired metal or alloy is heated (e.g., using resistance heating or an electron beam, for example) and consequently evaporated to form a metal vapor that may conformally coat exposed surfaces of the polymeric body, thereby forming the outer component 108 with the decorative surface coating 110 thereon.

Generally speaking, the decorative surface coating 110 may comprise a metal, as indicated above, a paint (e.g., comprising inorganic or organic pigments), or a polymer. In some examples, the decorative surface coating 110 may be a colored coating comprising a primary color or some combination or blend of primary colors. The decorative surface coating 110 may have a reflective, satin, or matte finish. The decorative surface coating 110 may have a thickness in a range from about 0.1 micron to about 100 microns, and more typically in the range from about 0.1 micron to about 10 microns, depending on the coating application method. The decorative surface coating 110 may be applied to one or more exterior-facing surfaces of the outer component 108.

As shown in FIGS. 1A-2B, the decorative surface coating 110 may be configured in full or in part as a circumferentially-extending band of substantially constant width. The outer component 108 may be configured and positioned such that the decorative surface coating 110 is continuous across front and side exterior portions of the electric cooking device 100. For example, the outer component 108 may include handle portions 116 configured to be seated with handles 118 on opposing sides of the lower housing 104, and the decorative surface coating 110 may extend over, or conformally coat, the handle portions 116. Referring again to FIGS. 2A and 2B, the inner component 112 may extend completely around an inner perimeter of the middle ring assembly 106, thereby defining a closed loop. The outer component 108 may extend at least partially around, or only partially around (as shown), an outer perimeter of the middle ring assembly 106.

A method of making the middle ring assembly 106 is also described. The method includes molding a coating-adherent polymer into a polymeric body having at least a partial ring shape (meaning a partial or full ring shape), and applying a decorative surface coating to the polymeric body to form an outer component. The decorative surface coating may be described as a conformal coating as it may conform to exposed contours of the polymer body. The decorative surface coating may be applied by vacuum metallization or physical vapor deposition, electroplating, powder coating, electrostatic painting, film insert molding, or co-molding. The decorative surface coating may be formed during or after the molding process, depending on the coating application method. One or more exterior facing surfaces of the outer component may include the decorative surface coating.

A heat-resistant polymer may be molded into a polymeric body having a full ring shape to form an inner component having an inner portion and an outer portion, the inner portion extending radially inward from the outer portion. The ring shape may comprise a generally circular, elliptical, polygonal, curved polygonal or other closed geometry (or unclosed geometry in the case of a partial ring shape). The molding of each of the coating-adherent polymer and the heat-resistant polymer may entail injection molding. After molding and application of the decorative surface coating 110, the outer portion 112a of the inner component 112 may be seated with the outer component 108, thereby forming the middle ring assembly 106, as shown in FIGS. 2A and 2B. The inner portion 112b of the inner component 112 may be unsupported by the outer component 108, and the inner portion 112b of the inner component 112 may be configured to engage a heated vessel 114 of an electric cooking device 100, as shown in FIGS. 1B and 3. The inner component 112 including the decorative surface coating 110 and the outer component 108 may have any or all of the features and/or properties described above or elsewhere in this disclosure.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. An electric cooking device comprising:
a removable lid and/or pot assembly;
a lower housing surrounding a vessel configured to be heated; and
a middle ring assembly positioned between the lower housing and the removable lid and/or pot assembly, the middle ring assembly comprising:
an outer component seated with the lower housing and having a decorative surface coating thereon,
an inner component having an outer portion seated with the outer component and an inner portion situated radially inward from and unsupported by the outer component,
wherein the vessel engages the inner portion of the inner component and is thereby thermally decoupled from the outer component comprising the decorative surface coating.

2. The electric cooking device of claim 1, wherein the inner portion of the inner component includes a vertically extending wall configured to support radially extending tabs on the vessel, the radially extending tabs thereby being vertically separated from the outer component when the vessel is engaged with the inner portion of the inner component.

3. The electric cooking device of claim 1, wherein the inner component extends completely around an inner perimeter of the middle ring assembly, thereby defining a closed loop.

4. The electric cooking device of claim 1, wherein the outer component extends at least partially around, or only partially around, an outer perimeter of the middle ring assembly.

5. The electric cooking device of claim 1, wherein one or more exterior facing surfaces of the outer component include the decorative surface coating.

6. The electric cooking device of claim 1, wherein the outer component includes handle portions seated with handles on opposing sides of the lower housing, and
wherein the decorative surface coating conformally coats the handle portions.

7. The electric cooking device of claim 1, wherein the decorative surface coating is configured in full or in part as a circumferentially-extending band of substantially constant width.

8. The electric cooking device of claim 1, wherein the vessel is configured to be heated up to or higher than an operating temperature of 240° F.

9. The electric cooking device of claim 1 being selected from the group consisting of: a pressure cooker and a dutch oven.

10. A middle ring assembly for an electric cooking device, the middle ring assembly comprising:
a ring structure comprising an inner component seated with an outer component, the inner component comprising a heat-resistant polymer and the outer component comprising a coating-adherent polymer with a decorative surface coating thereon.

11. The middle ring assembly of claim 10, wherein the heat-resistant polymer comprises:
a heat distortion temperature (HDT) higher than an operating temperature of the electric cooking device, and/or
a k-value of about 0.4 W/m·K or less.

12. The middle ring assembly of claim 11, wherein the HDT is at least 240° F. (116° C.) at 0.45 MPa.

13. The middle ring assembly of claim 10, wherein the heat-resistant polymer is selected from the group consisting of a polyamide (PA) such as nylon, polypropylene (PP), and polyethylene terephthalate (PET).

14. The middle ring assembly of claim 10, wherein the heat-resistant polymer includes reinforcement particles.

15. The middle ring assembly claim 14, wherein the reinforcement particles comprise glass fibers or glass beads.

16. The middle ring assembly of claim 10, wherein the coating-adherent polymer is selected from the group consisting of: acrylonitrile butadiene styrene (ABS), perfluoroalkoxy alkane (PFA), polyamide-imide (PAI), polyether ether ketone (PEEK), polycarbonate (PC), polyethylene (PE), a polyamide (PA) such as nylon, polymethyl methacrylate (PMMA), polytetrafluoroethylene (PTFE), polystyrene (PS), polyimide (PI), polyurethane (PU), poly(3,4-ethylenedioxythiophene)-poly(styrenesulfonate) (PEDOT:PSS), styrene butadiene block copolymer (SBC), high-density polyethylene (HDPE), polyvinyl chloride (PVC), polylactic acide (PLA), polysulfone, polypyrrolle (PPy), and polyoxymethylene (polyacetal).

17. The middle ring assembly of claim 10, wherein the decorative surface coating comprises a metal, a paint, or a polymer.

18. The middle ring assembly of claim 10, wherein the decorative surface coating is a metallic coating comprising one or more metals selected from the group consisting of: aluminum, chromium (“chrome”), copper, gold, nickel, silver, tin, titanium, and zinc.

19. The middle ring assembly of claim 10, wherein the decorative surface coating is a colored coating comprising a primary color or a blend of primary colors.

20. A method of forming a middle ring assembly for an electric cooking device, the method comprising:
molding a coating-adherent polymer into a polymeric body having at least a partial ring shape;
applying a decorative surface coating to the polymeric body, thereby forming an outer component;
molding a heat-resistant polymer into a polymeric body having a full ring shape, thereby forming an inner component having an inner portion and an outer portion, the inner portion extending radially inward from the outer portion; and
seating the outer portion of the inner component with the outer component, thereby forming the middle ring assembly,
wherein the inner portion of the inner component is unsupported by the outer component, and
wherein the inner portion of the inner component is configured to engage a heated vessel of an electric cooking device.
